(19) United States
(12) Patent Application Publication
(10) Pub. No.: US 2013/0139761 A1
(43) Pub. Date: Jun. 6, 2013

(54) System for Deterring Underwater Animals from an Underwater Region

(71) Applicant: Jeremy Ross Nedwell, Hampshire (GB)

(72) Inventor: Jeremy Ross Nedwell, Hampshire (GB)

(73) Assignee: FISH GUIDANCE SYSTEMS LIMITED, Southampton (GB)

(21) Appl. No.: 13/817,282

(22) PCT Filed: Aug. 1, 2011
(86) PCT No.: PCT/GB11/51452

§ 371 Date: Feb. 15, 2013

(30) Foreign Application Priority Data
Aug. 16, 2010 (GB) 1013714.9

(51) Int. Cl. E02B 1/00; A01K 61/00

(52) U.S. Cl. CPC E02B 1/006; A01K 61/00
USPC 119/219

(57) ABSTRACT

In order to deter underwater animals from an underwater region such as adjacent the entrance to an offtake pipe or channel from a river, sound and light are produced by sound and light producing units in the underwater region and are intermittently pulsed and/or at least one characteristic of the sound and light is repetitively modulated. At least some of the pulses of light and/or the occurrences of at least one feature in at least some of the light modulation repetitions are substantially synchronised with at least some of the pulses of sound and/or the occurrences of at least one feature in at least some of the sound modulation repetitions. For example, the sound may be frequency modulated, and the light may be pulsed when the sound frequency reaches its minimum. It is believed that this synchronisation of light and sound has a synergistic effect.

This invention relates to a system for and a method of deterring fish and other underwater animals from an underwater region.

It is well known to draw vast quantities of water from rivers, lakes and the sea in order, for example, to cool thermal power stations, to drive hydroelectric power stations and to provide irrigation and drinking water. Underwater animals can be drawn with the water, with the possible consequences of death and injury to the animals and damage to, and increased required maintenance of, plant and machinery.

A partial solution to this problem is to provide a physical screen or mesh across the offtake for the water. However, being pulled against or into the screen can cause death or injury to underwater animals. Also, the screen provides a good hunting ground for predators. Furthermore, the screen may become blocked by debris and will require regular maintenance.

Another partial solution to the problem is to deter the marine animals from the water offtake using behavioural screening. More particularly, the underwater region immediately upstream of the water offtake is bathed in an aversive stimulus, so that animals approaching the region find the stimulus unpleasant and turn away from the region. One known aversive stimulus is loud noise produced by an underwater loudspeaker. Another known aversive stimulus is formed by brilliant flashes of light produced by an underwater strobe discharge tube. Strobe discharge tubes of the type used for this purpose, produce a very bright flash of light for a very short duration, typically a few nanoseconds. Neither of these behavioural screening methods has proven to be completely effective. Furthermore, strobe discharge tubes have a limited life and require regular replacement.

An aim of the present invention, or at least of specific embodiments of it, is to provide a system for, and method of, deterring underwater animals from an underwater region which is more effective than the methods discussed above and which requires minimal maintenance.

In accordance with a first aspect of the invention, there is provided a system for deterring underwater animals from an underwater region, comprising: means for producing sound in the underwater region; means for producing light in the underwater region; and means for driving the sound and light producing means. The sound and light producing means are driven so that: the sound is intermittently pulsed and/or at least one characteristic of the sound is repetitively modulated; the light is intermittently pulsed and/or at least one characteristic of the light is repetitively modulated; and at least some of the pulses of light and/or the occurrences of at least one predetermined feature in at least some of the light modulation repetitions are substantially synchronised with at least some of the pulses of sound and/or the occurrences of at least one predetermined feature in at least some of the sound modulation repetitions.

It is believed that the synchronisation of the light and sound pulses and/or modulation repetitions has a synergistic effect in deterring underwater animals from the region. One possible explanation for this is as follows. A human may well find the sound alone of a nearby explosion frightening and want to move away from it, but be unsure of the direction in which to go. Also, a human seeing a bright flash of light nearby may find it startling, but not so frightening as the sound of the explosion, and they may not take any immediate action unless the flash of light is repeated and becomes annoying. However, if the explosive sound and the bright flash of light are combined, it is likely that the human reaction will immediately be to move in a direction away from the source of the light flash.

Preferably, the light is intermittently pulsed. The beginnings of at least some of the pulses of light may be substantially synchronised with the sound. However, in the case where each pulse of light has a duration which is less than the duration between the pulses of light, the pulses of light generally may be substantially synchronised with the sound. Each pulse of light preferably has a duration of at least 1 ms. The light producing means preferably comprises at least one LED, which typically has a longer life and requires less complex driver circuitry than a strobe tube emitting an equivalent amount of light energy but with pulses of far shorter duration. Alternatively, the light producing means may comprise at least one cold cathode light, halogen light or fluorescent light.

Alternatively or additionally, at least one characteristic of the light, such as its brightness or possibly its colour, may be repetitively modulated. The, or at least one of the, repetitively modulated characteristics of the light may be varied in value progressively. In this case, at least some of the maxima and/or minima in the value of the repetitively modulated characteristic of the light are preferably substantially synchronised with the sound. Alternatively, the, or at least one of the, repetitively modulated characteristics of the light may be varied in value in a stepwise fashion. In this case, at least some of the step changes in the value of the repetitively modulated characteristic of the light are preferably substantially synchronised with the sound.

Preferably, at least one characteristic of the sound, such as its pitch (i.e. frequency), volume or waveform, is repetitively modulated. In the case of waveform modulation, the waveform may be modulated between at least two of the following: a sine wave; a chopped sine wave; a square wave; a triangular wave; and a sawtooth wave. The, or at least one of the, repetitively modulated characteristics of the sound may be varied progressively. In the case of, for example, pitch or volume modulation, at least some of the maxima and/or minima in the value of the repetitively modulated characteristic of the sound may be substantially synchronised with the light. For example, the pitch of the sound may be progressively modulated between a high frequency and a low frequency, and a flash of light may be produced when the sound hits the high frequency. In the case of, for example, waveform modulation, at least some of repeating predetermined stages in the modulation repetitions of the sound may be substantially synchronised with the light. Alternatively or additionally, the, or at least one of the, repetitively modulated characteristics of the sound may be varied in a stepwise fashion. In this case, at least some of the step changes in the repetitively modulated characteristic of the sound may be substantially synchronised with the light.

Alternatively or additionally, the sound may intermittently pulsed. In this case, the beginnings of at least some of the pulses of sound may be substantially synchronised with the light. However, in the case where each pulse of sound has a duration which is less than the duration between the pulses of sound; the pulses of sound generally may be substantially synchronised with the light. For example, each pulse of sound, such as a crash, a bang or a sweep of a sine wave, may be synchronised with a flash of light.

The sound and/or the light is/are preferably modulated and/or pulsed at a modulation and/or pulse frequency no greater than 50 Hz. At higher modulation frequencies of the light, it is expected that underwater animals would not be able to perceive the modulation.

One pulse or modulation repetition of the sound may be provided for each pulse or modulation repetition of the light. Alternatively, a plurality of pulses or modulation repetitions of the sound may be provided for each pulse or modulation repetition of the light. For example, the pitch of the sound may be progressively modulated between a frequency note and a low frequency, and a flash of light may be produced every other time that the sound hits the high frequency. Alternatively, one pulse or modulation repetition of the sound may provided for a plurality of pulses or modulation repetitions of the light. For example, only one in three flashes of light may be accompanied by a crash of sound, or three flashes of light may occur as the sound is modulated between low and high frequencies, one being synchronised with the sound hitting the high frequency.

The pulsing and/or modulation of the sound and light may have a constant rate so as to be cyclic. On the other hand, the pulsing and/or modulation of the sound and light may have a modulated rate. It is believed that this may prevent habituation of the underwater animals to the light and sound produced by the system. Alternatively, the pulsing and/or modulation of the sound may be pseudo-random, with the light being substantially synchronised to the sound. On the other hand, the pulsing and/or modulation of the light may be pseudo-random, with the sound being substantially synchronised to the light. For example, the system may be arranged to produce flashes of light at pseudo-random intervals, with crashes of sound accompanying some, but not all, of the flashes of light in a regular or pseudo-random manner. Again, it is believed that this may prevent habituation of the underwater animals to the light and sound produced by the system.

In a particularly preferred embodiment of the invention, the driving means drives the sound and light producing means so that: the light producing means repetitively produces pulses of light; each light pulse has a duration of at least 1 ms; the pulses of light have a pulse frequency no greater 50 Hz; the sound producing means produces sound having its volume and/or pitch repetitively modulated; and at least one feature in each sound modulation repetition is substantially synchronised with the pulses of light.

The sound and light may be generated above the water and projected into the water, but the sound and light are preferably generated underwater in the region from which the underwater animals are to be deterred, in which case the sound and/or light producing means is/are preferably adapted to be usable underwater. The sound producing means and the light emitting means are preferably disposed adjacent each other. The underwater animals can therefore associate the light and the sound with each other.

In accordance with a second aspect of the invention, there is provided a method of deterring underwater animals from an underwater region. The method comprises producing sound in the underwater region and producing light in the underwater region. The sound is intermittently pulsed and/or at least one characteristic of the sound is repetitively modulated. The light is intermittently pulsed and/or at least one characteristic of the light is repetitively modulated. At least some of the pulses of light and/or the occurrences of at least one feature in at least some of the light modulation repetitions are substantially synchronised with at least some of the pulses of sound and/or the occurrences of at least one feature in at least some of the sound modulation repetitions.

The method of the second aspect of the invention preferably includes any of the steps or functions described above as provided by the system of the first aspect of the invention.

Specific embodiments of the present invention will now be described, purely by way of example, with reference to the accompanying drawings, in which:

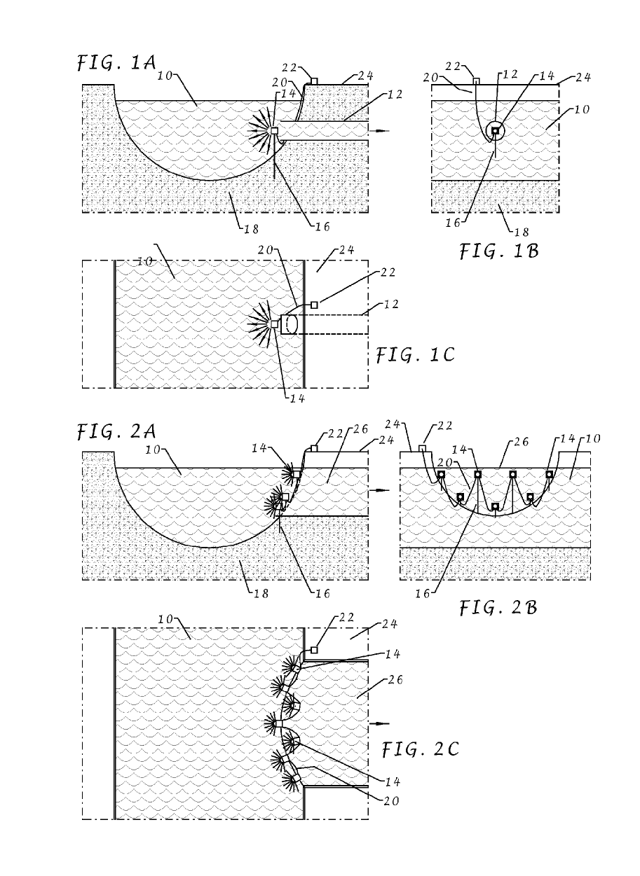

FIGS. 1A-C are schematic cross-sectioned, longitudinally-sectioned and plan views, respectively, of a river having an offtake pipe installed with a fish deterrent system;

FIGS. 2A-C are schematic cross-sectioned, longitudinally-sectioned and plan views, respectively, of a river having an offtake channel installed with a fish deterrent system;

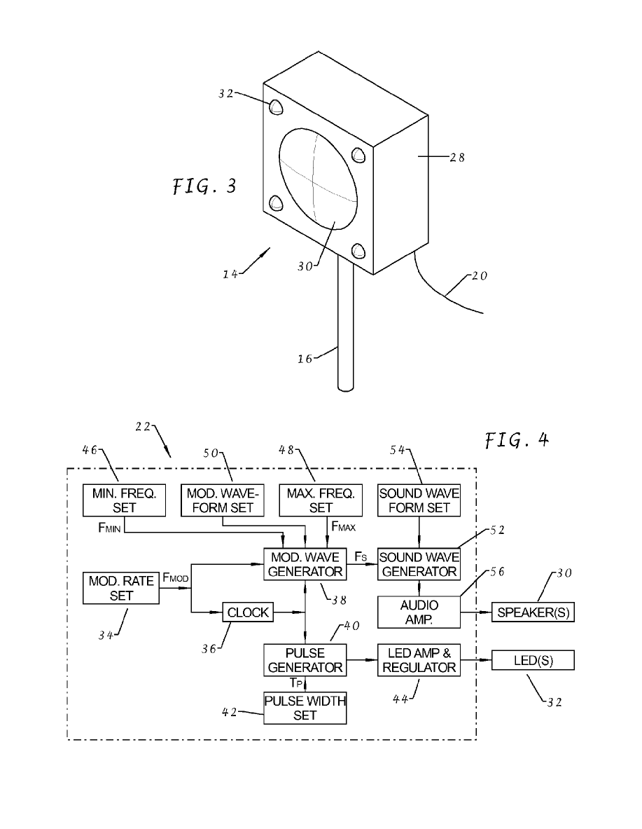

FIG. 3 is a schematic isometric view of a combined sound and light producing unit of a fish deterrent system;

FIG. 4 is a schematic diagram of one embodiment of driving circuit for the sound and light producing unit(s);

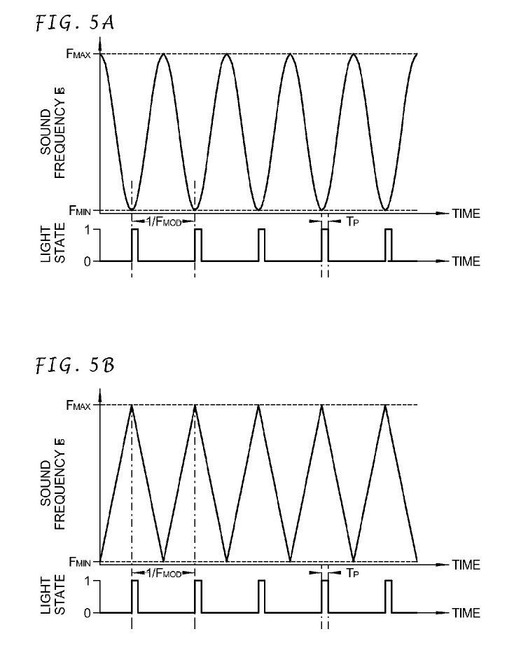

FIGS. 5A & B are wave diagrams illustrating two different modes of operation of the circuit of FIG. 4;

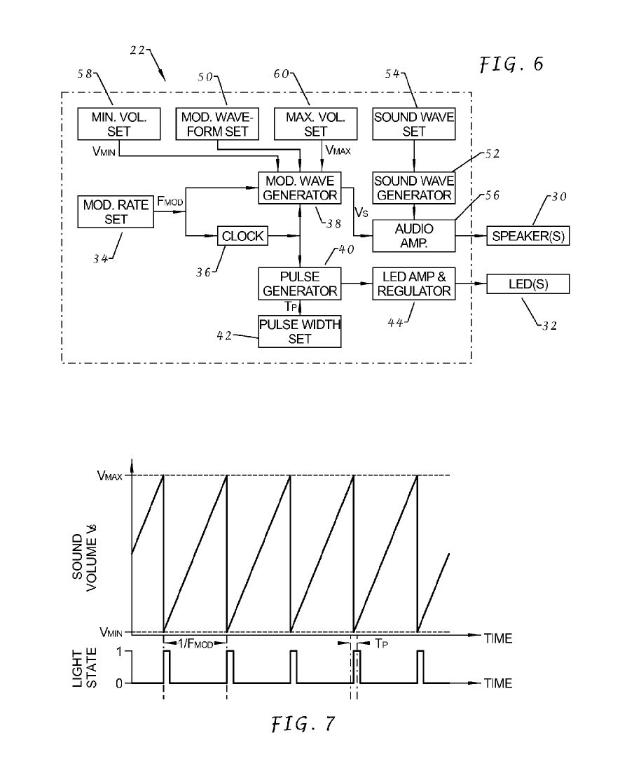

FIG. 6 is a schematic diagram of another embodiment of driving circuit for the sound and light producing unit(s);

FIG. 7 is a wave diagram illustrating operation of the circuit of FIG. 7;

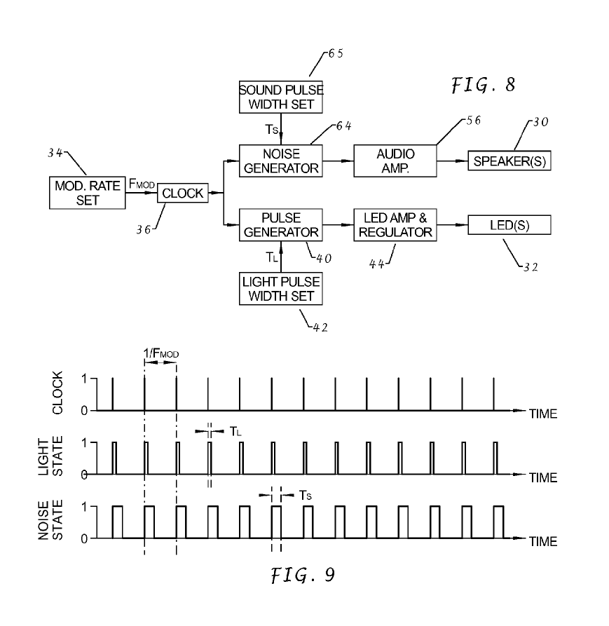

FIG. 8 is a schematic diagram of a further embodiment of driving circuit for the sound and light producing unit(s);

FIG. 9 is a wave diagram illustrating operation of the circuit of FIG. 8;

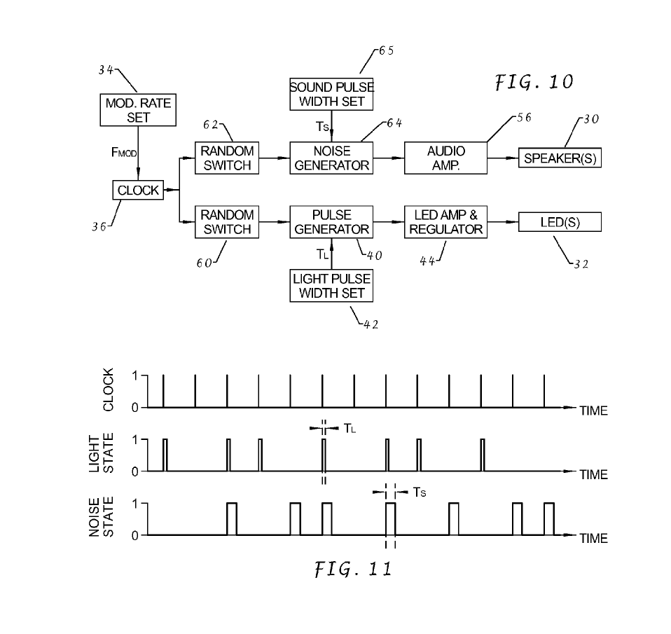

FIGS. 10 & 11 illustrate a modification to the arrangement of FIGS. 8 and 9; and

FIGS. 12-15 are wave diagrams illustrating alternative operations of the driving circuit.

Referring to FIGS. 1A-C, in one example of installation of a fish deterrent system, a river 10 has an underground offtake pipe 12, through which water is drawn to an irrigation system (not shown). A combined sound and light producing unit 14 is mounted on a post 16 set into the river bed 18 adjacent the inlet end of the offtake pipe 12 and is connected by a cable 20 to a driver unit 22 disposed on the river bank 24. In use, the sound and light unit 14 radiates synchronised sound and light away from the inlet end of the offtake pipe 12 over a wide angle of, for example, 180 degrees, with the primary axis of radiation approximately aligned with the offtake pipe 12. The synchronised sound and light deters fish in the river 10 away from the inlet end of the offtake pipe 12.

Referring to FIGS. 2A-C, in another example of installation of a fish deterrent system, a river 10 has an offtake channel 26, along which water is drawn to power station (not shown). Seven combined sound and light producing units 14 are mounted on posts 16 set into the river bed 18 or channel bed adjacent the inlet end of the offtake channel 26 and spread across the inlet end of the offtake channel 26. The sound and light producing units are connected by a cable 20 to a driver unit 22 disposed on the river bank 24. In use, the sound and light units 14 radiate synchronised sound and light away from the inlet end of the offtake channel 26 over a wide angle of, for example, 180 degrees. As shown in FIG. 2C, the sound and light producing units 14 may be oriented so that their primary axes of radiation are not parallel so as to improve the distribution of sound and light. The synchronised sound and light deter fish in the river 10 from the inlet end of the offtake channel 26.

Referring to FIG. 3, each sound and light producing unit 14 comprises a waterproof cabinet 28 containing a waterproof loudspeaker 30 and a number of LEDs 32 which have their electrical connections protected from the water. The loudspeaker 30 is sufficiently powerful to produce a sound level of about 160 dB re luPa. Although four LEDs 32 are shown in the drawing, a considerably larger number of LEDs 32 may be included in the unit 14, for example eighty. Each LED 32 might typically have a power consumption of 2 W. The LEDs 32 may be arranged all to radiate light in the same direction, or they may be at various angles in order to obtain a required light distribution pattern. The LEDs 32 may produce white light, but other colours of light may also be effective. The connecting cable 20 for the sound and light producing unit 14 carries a drive signal for the loudspeaker 30 and a separate drive signal for the LEDs 32.

Referring to FIG. 4, in one example of the driver unit 22, a modulation rate setting device 34 produces a signal representing a desired modulation rate F_{MOD} in the range, for example, between 1 Hz and 50 Hz, which is supplied to a clock 36 and to a modulation wave generator 38. The clock 36 produces a square wave signal at the modulation rate F_{MOD} which is supplied to a pulse generator 40 and to the modulation wave generator 38. A pulse width setting device 42 produces a signal representing a desired pulse width T_{P} for the light pulses, for example between 1 ms and 500 ms (and more preferably about 20 ms) and less than the inverse 1/F_{MOD} of the modulation rate F_{MOD}. The pulse generator 40 produces a series of rectangular pulses at the modulation rate F_{MOD}, each pulse beginning with a positive-going transition in the clock signal, and each pulse having the pulse width T_{P}. The series of pulses is supplied from the generator 40 to an amplifier and regulator 44 which drives the LEDs 32 at their appropriate current so that they flash with each flash beginning with a positive-going transition in the clock signal, and each flash having the pulse width T_{P}. A minimum sound frequency setting device 46 and a maximum sound frequency setting device 48 produce signals representing the minimum sound frequency F_{MIN} and the maximum sound frequency F_{MAX}, respectively, and these signals are supplied to the modulation wave generator 38. The minimum and maximum sound frequencies F_{MIN}, F_{MAX} may, for example, be 10 Hz and 500 Hz, respectively. Also, a modulation waveform setting device 50 produces a signal representing whether the sound modulation is to have a sine waveform, a square waveform, a triangular waveform, a sawtooth waveform or a more complex waveform, and this signal is also supplied to the modulation wave generator 38. The modulation wave generator 38 produces a sound-frequency signal Fs which: (a) is modulated between the minimum sound frequency F_{MIN} and the maximum sound frequency F_{MAX} at the modulation rate F_{MOD}; (b) has a waveform as indicated by the modulation waveform setting device 50; and (c) has a particular feature in the waveform (such a maximum, a minimum or a step change) synchronised with a positive-going transition in the clock signal from the clock 36. The sound frequency signal F_{S} is supplied to a sound wave generator 52, as too is a signal from a sound waveform setting device 54 representing the waveform of the required sound, such as a sine waveform, a square waveform, a triangular waveform or a sawtooth waveform. The sound wave generator 52 produces an audio signal having a waveform as indicated by the sound waveform setting device 54 and a frequency as indicated by the sound-frequency signal Fs. The audio signal is supplied to an audio amplifier 56 which amplifies the signal to a level suitable for supply to the loudspeakers 30.

FIG. 5A illustrates an example where the modulation waveform as set by the device 50 is a sine wave which has its minimum synchronised. The frequency F_{S} of the sound produced by the loudspeaker(s) 30 is therefore swept up and down sinusoidally between a maximum frequency F_{MAX} and a minimum frequency F_{MIN} at a modulation rate F_{MOD}, and each time the sound frequency F_{S} is a minimum the LEDs 32 produce a flash of light having a flash duration T_{P}. It should be noted that FIG. 5A shows the frequency of the sound, and not the audio waveform nor the audio volume. The audio waveform is as set by the setting device 54.

FIG. 5B illustrates another example where the modulation waveform as set by the device 50 is a triangular wave which has its maximum synchronised. The frequency Fₛ of the sound produced by the loudspeaker(s) 30 is therefore modulated linearly at a modulation rate F_{MOD} between a maximum frequency F_{MAX} and a minimum frequency F_{MIN}, and each time the sound frequency F_{S} is a maximum the LEDs 32 produce a flash of light having a flash duration T.

Referring to FIG. 6, another embodiment of the driver unit 22 is similar to the unit described with reference to FIG. 4, except that it modulates the volume of the sound. Specifically, the minimum and maximum frequency setting devices 46,48 are replaced by minimum and maximum volume setting devices 58,60 which provide signals V_{MIN}, V_{MAX}, respectively, representing the minimum and maximum volume of the sound. The modulation wave generator 38 therefore produces a sound volume signal V_{S}, which (a) is modulated between the minimum sound volume V_{MIN} and the maximum sound volume V_{MAX} at the modulation rate F_{MOD}; (b) has a waveform as indicated by the modulation waveform setting device 50; and (c) has a particular feature in the waveform (such a maximum, a minimum or a step change) synchronised with a positive-going transition in the clock signal from the clock 36. The sound volume signal V_{S} is supplied to a volume input of the audio amplifier 56. The device 54 sets not only the desired waveform of the sound, but also its frequency.

FIG. 7 illustrates an example where the modulation waveform as set by the device 50 is a sawtooth wave which has its maximum synchronised. The volume V_{S} of the sound produced by the loudspeaker(s) 30 therefore increases linearly over a period 1/F_{MOD} from a minimum volume V_{MIN} to a maximum volume V_{MAX}, and each time the maximum volume V_{MAX} is reached, the LEDs 32 produce a flash of light having a flash duration T_{P}, and the volume V_{S} immediately drops back to the minimum volume V_{MIN}.

A further embodiment of the driver unit 22 is shown in FIG. 8. A modulation rate setting device 34 produces a signal representing a desired modulation rate F_{MOD} between, for example, 1 Hz and 50 Hz, which is supplied to a clock 36. The clock 36 produces a rectangular wave signal at the modulation rate F_{MOD} and with a small mark:space ratio, which is supplied to a pulse generator 40 and a noise generator 64. A pulse width setting device 42 produces a signal representing a desired pulse width T_{L} for the light pulses, for example between 1 ms and 500 ms and less than the inverse 1/F MOD of the modulation rate F_{MOD}. The pulse generator 40 produces, for each clock pulse received, a rectangular pulse which has a pulse duration T_{L} and which is passed to the LED amplifier and regulator 44 and then to the LEDs 32. A further pulse width setting device 65 produces a signal representing a desired pulse width Tₛ for the sound, for example between 1 ms and 500 ms and less than the inverse 1/F_{MOD} of the modulation rate F_{MOD}. The noise generator 64 produces, for each clock pulse received a burst of noise which has a pulse duration T_{S} and which is passed to the audio amplifier 56 and then to the loudspeaker(s) 30, which produce a burst of audio, for example sounding like a bang or a crash. Therefore, as shown in FIG. 9, for each clock pulse produced by the clock 36 at the frequency F_{MOD}, the LEDs 32 produce a flash of light of duration T_{L} and the loudspeaker 30 produces a burst of noise of duration T_{S}, with the beginning of each burst of noise being synchronised with the beginning of a flash of light.

A development of the embodiment of FIGS. 8 and 9 is shown in FIGS. 10 and 11. In this case, a pair of random switches 60,62 are disposed between the clock 36 and the pulse and noise generators 40,64, respectively. The random switches 60,62 independently and randomly decide whether or not to pass the pulses of the clock signal to the pulse generator 40 and the noise generator 64. Therefore, as shown in FIG. 11, for each clock pulse produced by the clock 36 at the modulation rate F_{MOD}, there is one of four outcomes: (1) the LEDs 32 produce a flash of light of duration T_{L} and the loudspeaker 30 produces a burst of noise of duration T_{S} synchronised with the flash of light; (2) the LEDs 32 produce a flash of light of duration T_{L} but the loudspeaker 30 is quiet; (3) the loudspeaker 30 produces a burst of noise of duration T_{S}, but the LEDs 32 do not flash; or (4) the LEDs 32 do not flash, and the loudspeaker 30 is quiet.

It will be appreciated that many modifications and developments may be made to the embodiments described above.

For example, in the circuits of FIGS. 4 and 6, the type of modulation waveform, the type of sound waveform, and the maximum and minimum sound frequencies F_{MAX}, F_{MIN} may be permanently set. In the circuits of FIGS. 4, 6 and 8, the light pulse width T_{P} or T_{L} may be permanently set. In the circuit of FIG. 8, the sound pulse width T_{S} may be permanently set.

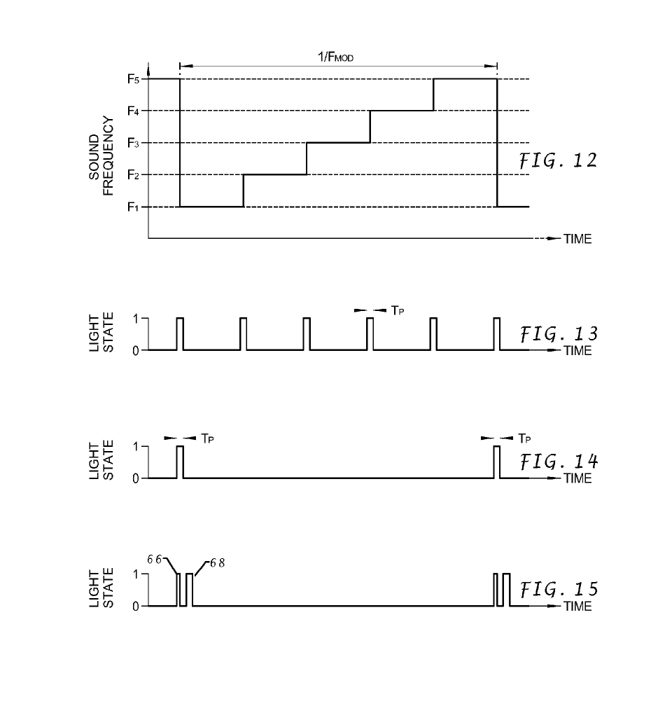

In the circuits of FIGS. 4 and 6, the sound frequency need not be progressively swept; instead, as shown in FIG. 12, the sound frequency may hop between two or more different frequencies, with a light pulse being synchronised with all of the frequency hops, as shown in FIG. 13, or only some of the frequency hops, as shown in FIG. 14. In this case, different frequency hops may be synchronised with light pulses of different pulse widths. Also, as shown in FIG. 15, in addition to the synchronised light pulses 66, other light pulses 68 of the same or a different duration may also be included.

In the circuits of FIGS. 4 and 6, instead of modulating the frequency or volume of the sound, the waveform of the sound may be modulated, for example by hopping between a sine waveform and a square waveform, or progressively changing between sine and square waveforms.

Although the circuits of FIGS. 4, 6 and 8 produce sharp pulses of light, the brightness of the light may instead be progressively modulated in a similar fashion to the sound volume modulation described with reference to FIG. 6. Also, the colour of the light may be modulated in addition to, or instead of, the brightness.

In the circuits described above, the modulation rate F_{MOD} need not be constant. Indeed, it may be varied so much, especially in the case of the circuit of FIG. 8 that the pulses of light and bursts of sound become quasi random, but with at least some of the pulses of light be synchronised with some of the bursts of sound.

It is possible that underwater animals exposed to any repetitive sound and light combination may become habituated if they stay in the vicinity of the offtake 10,26 for a prolonged period. In other words, their response to the stimulus may become reduced in time as they become used to the stimulus. In this case, it may be useful to change the lights and sounds from time to time, or to vary them over a long time. For example, in the circuits of FIGS. 4 and 6, the modulation rate F_{MOD}, the maximum and minimum frequencies F_{MAX}, F_{MIN}, the modulation waveform, the sound waveform, the light pulse width T_{P} and/or the maximum and minimum volumes V_{MAX}, V_{MIN} may be varied progressively with time, or changed from time to time.

In the embodiments described above, the flashes of light have a relatively short duration T_{P}, and the synchronising feature of the sound is synchronised with the beginning of each light flash. The synchronising features of the sound (i.e. a minimum, a maximum, or a step change) may, instead be synchronised with the middle or the end of each light pulse.

It should be noted that the embodiments of the invention have been described above purely by way of example and that many other modifications and developments may be made thereto within the scope of the present invention.

1-39. (canceled)

40. A system for deterring underwater animals from an underwater region, comprising: means for producing sound in the underwater region; means for producing light in the underwater region; and means for driving the sound and light producing means so that: the sound is intermittently pulsed and/or at least one characteristic of the sound is repetitively modulated; the light is intermittently pulsed and/or at least one characteristic of the light is repetitively modulated; and at least some of the pulses of light and/or the occurrences of at least one predetermined feature in at least some of the light modulation repetitions are substantially synchronised with at least some of the pulse of sound and/or the occurrences of at least one predetermined feature in at least some of the sound modulation repetitions.

41. A system as claimed in claim 40, wherein: the light is intermittently pulsed.

42. A system as claimed in claim 41, wherein: the beginnings of at least some of the pulses of light are substantially synchronised with the sound.

43. A system as claimed in claim 41, wherein: each pulse of light has a duration which is less than the duration between the pulses of light; and the pulse of light are substantially synchronised with the sound.

44. A system as claimed in claim 41, wherein: each pulse of light has a duration of at least 1 ms.

45. A system as claimed in claim 40, wherein: at least one characteristic of the light is repetitively modulated.

46. A system as claimed in claim 45, wherein: at least some of the maxima and/or minima in the value of the repetitively modulated characteristic of the light are substantially synchronised with the sound.

47. A system as claimed in claim 45, wherein: the, or at least one of the repetitively modulated characteristics of the light is varied in value in a stepwise fashion.

48. A system as claimed in claim 47, wherein: at least some of the step changes in the value of the repetitively modulated characteristic of the light are substantially synchronised with the sound.

49. A system as claimed in claim 40, wherein: at least one characteristic of the sound is repetitively modulated.

50. A system as claimed in claim 49, wherein: the, or at least one of the, repetitively modulated characteristics of the sound is the pitch of the sound.

51. A system as claimed in claim 49, wherein: the, or at least one of the, repetitively modulated characteristics of the sound is the volume of the sound.

52. A system as claimed in claim 49, wherein: the, or at least one of the, repetitively modulated characteristics of the sound is the waveform of the sound.

53. A system as claimed in claim 52, wherein: the waveform of the sound is modulated between at least two of the following: a sine wave; a chopped sine wave; a square wave; a triangular wave; and a sawtooth wave.

54. A system as claimed in claim 49, wherein: the, or at least one of the, repetitively modulated characteristics of the sound is varied progressively.

55. A system as claimed in claim 54, wherein: at least some of the maxima and/or minima in the value of the repetitively modulated characteristic of the sound are substantially synchronised with the light.

56. A system as claimed in claim 54, wherein: at least some of repeating predetermined stages in the modulation repetitions of the sound are substantially synchronised with the light.

57. A system as claimed in claim 49, wherein: the, or at least one of the, repetitively modulated characteristics of the sound is varied in a stepwise fashion.

58. A system as claimed in claim 57, wherein: at least some of the step changes in the repetitively modulated characteristic of the sound are substantially synchronised with the light.

59. A system as claimed in claim 40, wherein: the sound is intermittently pulsed.

60. A system as claimed in claim 59, wherein: the beginnings of at least some of the pulses of sound are substantially synchronised with the light.

61. A system as claimed in claim 59, wherein: each pulse of sound has a duration which is less than the duration between the pulses of sound; and the pulses of sound are substantially synchronised with the light.

62. A system as claimed in claim 40, wherein: one pulse or modulation repetition of the sound is provided for each pulse or modulation repetition of the light.

63. A system as claimed in claim 40, wherein: a plurality of pulses or modulation repetitions of the sound are provided for each pulse or modulation repetition of the light.

64. A system as claimed in claim 40, wherein: one pulse or modulation repetition of the sound is provided for a plurality of pulses or modulation repetitions of the light.

65. A system as claimed in claim 40, wherein: the pulsing and/or modulation of the sound and light has a constant rate.

66. A system as claimed in claim 40, wherein: the pulsing and/or modulation of the sound and light have a modulated rate.

67. A system as claimed in claim 40, wherein: the pulsing and/or modulation of the sound or light is pseudo-random; and the light is substantially synchronized to the sound or the sound is synchronised to the light.

68. A system as claimed in claim 40, wherein: the driving means drives the sound and light producing means so that: the light producing means repetitively produces pulses of light; each light pulse has a duration of at least 1 ms; the pulses of light has a pulse frequency no greater 50 Hz; the sound producing means produces sound having its volume and/or pitch repetitively modulated; and at least one feature in each sound modulation repetition is substantially synchronised with the pulse of light.
